(19) United States
(12) Patent Application Publication
(10) Pub. No.: US 2025/0391318 A1
(43) Pub. Date: Dec. 25, 2025

(54) DISPLAY DEVICE AND DRIVING METHOD OF DISPLAY DEVICE

(71) Applicant: Samsung Display Co., LTD., Yongin-si (KR)

(72) Inventor: Si Beak PYO, Yongin-si (KR)

(21) Appl. No.: 19/010,648

(22) Filed: Jan. 6, 2025

(30) Foreign Application Priority Data
Jun. 25, 2024 (KR) 10-2024-0082867

(51) Int. Cl. G09G 3/32

(52) U.S. Cl. CPC G09G 3/32; G09G 2310/0267; G09G 2310/0275; G09G 2320/0233; G09G 2320/0276; G09G 2320/0285; G09G 2330/021

(57) ABSTRACT

The display device changes a power voltage step by step based on the display brightness value (DBV) and displays an image with the maximum luminance corresponding to the DBV. The display device may sense a first DBV where a step occurs in the power voltage, may set an offset for the DBV based on the first DBV, may correct gamma voltage values based on the DBV based on the offset, and may generate a data voltage based on the corrected gamma voltage values.

This application claims priority to Korean Patent Application No. 10-2024-0082867, filed on Jun. 25, 2024, and all the benefits accruing therefrom under 35 U.S.C. § 119, the content of which in its entirety is herein incorporated by reference.

### BACKGROUND

### 1. Field

Embodiments of the present invention relate to a display device and a driving method of the display device.

### 2. Description of the Related Art

A display device may include a display panel, a driver, and a power supply. The display panel may include pixels connected to data lines. The driver may provide data voltage to the data line. The power supply may provide driving power to the display panel and the driver.

In some cases, the maximum luminance of the display panel (or image) may be adjusted based on a display brightness value, and the driver may adjust the data voltage based on the display brightness value. In some aspects, the power supply may adjust a voltage level of the driving power based on the display brightness value.

### SUMMARY

Embodiments supported by the present disclosure provides a display device with improved display quality and a driving method of the display device.

The object of the present disclosure is not limited to the aforesaid, but other objects not described herein will be clearly understood by those skilled in the art from descriptions below.

A driving method of a display device according to embodiments of the present invention may be performed in the display device that changes a power voltage step by step based on a display brightness value DBV and displays an image with a maximum luminance corresponding to the DBV. The driving method includes sensing a first DBV where a step occurs in the power voltage; setting an offset for the DBV based on the first DBV; correcting gamma voltage values based on the DBV based on the offset; and generating a data voltage based on the corrected gamma voltage values.

The driving method may include setting a voltage level of the power voltage using a lookup table stored in a memory, and the lookup table may include information on voltage levels of the power voltage based on one or more DBVs within a DBV range.

The sensing the first DBV may include determining a voltage level at each step of the power voltage by interpolating voltage levels in the lookup table; and determining the first DBV based on the voltage level at the each step.

The setting the offset may include setting a first offset for the first DBV corresponding to a starting point of the step, and setting a second offset for the second DBV corresponding to an ending point of the step.

The first offset may be set such that luminance of the display device is lowered within a correction range, and the second offset may be set such that the luminance is higher within the correction range.

The driving method may include setting the correction range to be the same at each of the steps of the power voltage.

A range of the DBV may be divided into DBV sections, each of the DBV sections corresponds to at least one of the steps of the power voltage, and the correction range may be set differently for each DBV section.

The gamma lookup table may include information on gamma voltages based on one or more DBVs within the DBV range and may be stored in a memory. The correcting the gamma voltage values may include calculating first gamma voltage values for the first DBV and second gamma voltage values for the second DBV based on the gamma lookup table, correcting the first gamma voltage values for the first DBV and the second gamma voltage values for the second DBV based on the first offset and the second offset, interpolating the corrected first gamma voltage values and the corrected second gamma voltage values and calculating, based on the interpolating, gamma voltage values based on the DBV.

Setting the offset for the DBV may be based on the first offset and the second offset.

The gamma lookup table may include information on gamma voltages based on one or more DBVs within the DBV range and may be stored in a memory, and the correcting the gamma voltage values may include: interpolating the gamma voltages based on the one or more DBVs and obtaining, based on the interpolating, the gamma voltage values based on the DBV, and reflecting the offset in the gamma voltage values based on the DBV.

The data voltage for a first grayscale may change linearly based on the DBV in a DBV section in which the power voltage is maintained constant, and change nonlinearly or discontinuously in a DBV section in which the step of the power voltage occurs or the first DBV.

The display device may include a light emitting element, and the driving method may include applying the power voltage to a cathode electrode of the light emitting element.

The display device may include a light emitting element and a driving transistor connected to an anode electrode of the light emitting element, and the driving method may include applying the power voltage to the anode electrode of the light emitting element.

The display device may include a light emitting element and a driving transistor connected to an anode electrode of the light emitting element, and the driving method may include applying the power voltage to a gate electrode of the driving transistor.

The display device may include a scan driver that drives a display panel, and the driving method may include providing the power voltage may be provided to the scan driver.

A display device according to embodiments of the present invention includes a display panel including pixels; a data driver configured to provide a data voltage to the display panel; a scan driver configured to provide a scan signal to the display panel; and a power supply unit that configured to provide a power voltage to the display panel and change the power voltage step by step based on a display brightness value DBV. The display panel may be configured to display an image with maximum luminance corresponding to the DBV. The data driver may be configured to correct gamma voltage values in a first DBV where a step occurs in the power voltage and generate a data voltage based on the corrected gamma voltage values. The data voltage for a first grayscale may change linearly based on the DBV in the DBV section where the power voltage is maintained constant, and change non-linearly or a discontinuously in the DBV section where the step of the power voltage occurs or the first DBV.

The display device may further include a memory for storing a lookup table, wherein the lookup table includes information on voltage levels of the power voltage based on one or more DBVs within a DBV range, and the data driver may be configured to determine a voltage level at each step of the power voltage by interpolating voltage levels in the lookup table, and determine the first DBV based on the voltage level at the each step.

The data driver may be configured to set an offset for the DBV based on the first DBV and correct the gamma voltage values based on the DBV based on the offset.

The data driver may be configured to set a first offset for the first DBV corresponding to a starting point of the step and set a second offset for the second DBV corresponding to an ending point of the step.

The data driver may set the first offset such that luminance of the display panel is lowered within a correction range, and may set the second offset such that the luminance of the display panel is higher within the correction range.

Specific details of other embodiments are included in specification and drawings.

A display device and a driving method of the display device according to embodiments of the present invention may sense a display brightness value DBV at which a step occurs in the power voltage, may set or correct an offset to reduce luminance error based on the display brightness value DBV, and may generate or correct gamma voltages based on the offset. Accordingly, the contrast effective luminance (or luminance error) can be reduced, and the display quality of the display device can be improved.

Effects according to embodiments are not limited by the example contents above, and more various effects are included in the present specification.

### BRIEF DESCRIPTION OF THE DRAWINGS

FIG. 1 is a block diagram illustrating a display device according to embodiments.

FIG. 2 is a circuit diagram illustrating an embodiment of a pixel included in a display device of FIG. 1.

FIG. 3 is a block diagram illustrating an embodiment of a data driver included in a display device of FIG. 1.

FIG. 4 is a drawing illustrating an embodiment of a gamma lookup table used in a data converter of FIG. 3.

FIG. 5 is a graph illustrating a relationship between a display brightness value and luminance.

FIG. 6 is a graph illustrating a relationship between grayscales and voltage values.

FIG. 7 is a drawing illustrating an example of a lookup table used in a power supply unit of FIG. 1.

FIG. 8 is a drawing illustrating a first power voltage based on a display brightness value.

FIG. 9 is a drawing illustrating contrast effective luminance based on a display brightness value.

FIG. 10 is a block diagram illustrating an embodiment of a data converter of FIG. 3.

FIG. 11 is a drawing illustrating a data voltage and a first power voltage based on a display brightness value.

FIG. 12 is a flowchart illustrating a driving method of a display device according to embodiments.

FIG. 13 is a block diagram of an electronic device according to an embodiment.

FIG. 14 shows schematic views of various embodiments of an electronic device.

### DETAILED DESCRIPTION

It will be apparent to those skilled in the art that various modifications and variations can be made in the present disclosure without departing from the spirit or scope of the disclosure, and specific example embodiments are described in the drawings and explained in the detailed description. Thus, it is intended that the present invention covers the modifications and variations of this invention provided they come within the scope of the present invention and their equivalents.

The terms, ‘first’, ‘second’ and the like may be simply used for description of various constituent elements, but those meanings may not be limited to the restricted meanings. The terms are used for distinguishing one constituent element from other constituent elements. For example, a first constituent element may be referred to as a second constituent element and similarly, the second constituent element may be referred to as the first constituent element within the scope of the appended claims. In an example in which explaining the singular, unless explicitly described to the contrary, it may be interpreted as the plural meaning.

In the specification, the word “comprise” or “has” is used to specify existence of a feature, a numbers, a process, an operation, a constituent element, a part, or a combination thereof, and it will be understood that existence or additional possibility of one or more other features or numbers, processes, operations, constituent elements, parts, or combinations thereof are not excluded in advance.

The terms “about” or “approximately” as used herein are inclusive of the stated value and include a suitable range of deviation for the particular value as determined by one of ordinary skill in the art, considering the measurement in question and the error associated with measurement of the particular quantity. The terms “about” or “approximately” can mean within one or more standard deviations, or within ±30%, 20%, 10%, 5% of the stated value, for example.

Advantages and features of the present invention, and implementation methods thereof will be clarified through following embodiments described with reference to the accompanying drawings. Embodiments supported by the present disclosure may, however, be embodied in different forms and should not be construed as limited to the embodiments set forth herein. In this disclosure below, when one part (or element, device, or the like) is referred to as being ‘connected’ to another part (or element, device, or the like), it should be understood that the former can be ‘directly connected’ to the latter, or ‘electrically connected’ to the latter via an intervening part (or element, device, or the like). In an embodiment of the present invention, “connection” between two components may mean using both electrical and physical connections.

Some embodiments may be described in the accompanying drawings in relation to functional blocks, units and/or modules. Those skilled in the art will understand that such blocks, units, and/or modules are physically implemented by logic circuits, discrete components, microprocessors, hard-wired circuits, memory elements, wiring connections, and other electronic circuits. It may be formed using semiconductor-based manufacturing technology or other manufacturing technology. Blocks, units, and/or modules implemented by a microprocessor or other similar hardware may be programmed and controlled using software to perform various functions discussed in the present invention and may be driven by firmware and/or software optionally. In some aspects, each block, unit, and/or module may be implemented by dedicated hardware or may be implemented as a combination of a processor (e.g., one or more programmed microprocessors and related circuits) that performs functions different from the dedicated hardware that performs some functions. Further, in some embodiments, blocks, units and/or modules may be physically separated into two or more individual blocks, units and/or modules that interact in a scope of a concept of the present invention. Further, in some embodiments, blocks, units and/or modules may be physically combined into more complex blocks, units and/or modules in the scope of a concept of the present invention.

Hereinafter, a display device according to an embodiment of the present invention will be described with reference to drawings related to the embodiments of the present invention.

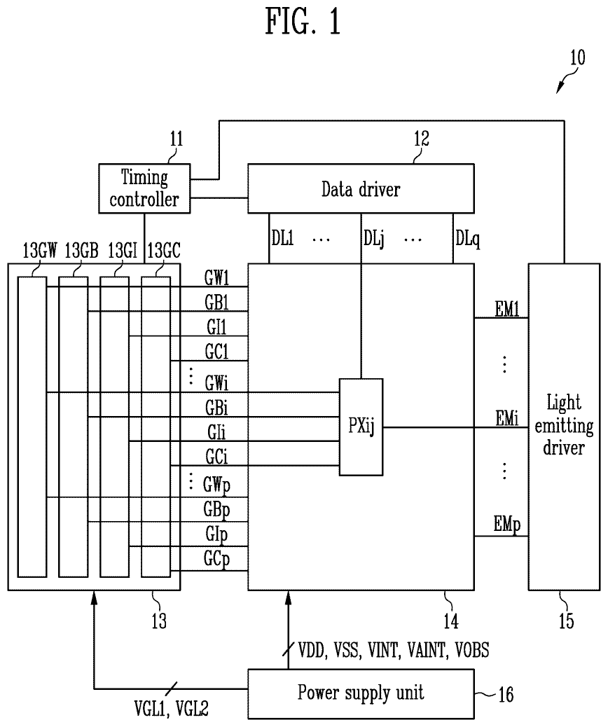

FIG. 1 is a block diagram illustrating a display device according to embodiments.

Referring to FIG. 1, the display device 10 includes a timing controller 11, a data driver 12, a scan driver 13, a pixel unit 14, a light emitting driver 15, and a power supply unit 16.

The timing controller 11 may receive grayscales (or grayscale values) for an input image (or input frame). The grayscales may include a first color grayscale, a second color grayscale, and a third color grayscale. The first color grayscale may be a grayscale for expressing the first color, the second color grayscale may be a grayscale for expressing the second color, and the third color grayscale may be a grayscale for expressing the third color. In some aspects, the timing controller 11 may receive a control signal for the image. These control signals may include a horizontal synchronization signal (Hsync), a vertical synchronization signal (Vsync), and a data enable signal. The vertical synchronization signal may include a plurality of pulses, and may indicate that the previous frame period ends and the current frame period starts based on the time when each pulse occurs. An interval between adjacent pulses in the vertical synchronization signal may correspond to one frame period. The horizontal synchronization signal may include a plurality of pulses, and may indicate that the previous horizontal period ends and a new horizontal period starts based on the time when each pulse occurs. An interval between adjacent pulses of the horizontal synchronization signal may correspond to one horizontal period. The data enable signal may have an enable level (e.g., a first voltage level, a first logic level) for certain horizontal periods and a disable level (e.g., a second voltage level, a second logic level) for the remaining periods. The data enable signal may indicate that color grayscales are supplied in the corresponding horizontal periods, when the data enable signal is at an enable level.

The timing controller 11 may provide grayscales rendered or corrected to meet the specifications of the display device 10 to the data driver 12. In some aspects, the timing controller 11 may provide a clock signal, a scan start signal, or other signals supportive of aspects of the present disclosure to the scan driver 13. The timing controller 11 may provide a clock signal, a light emitting stop signal, or other signals supportive of aspects of the present disclosure to the light emitting driver 15.

The data driver 12 may generate data voltages to be provided to the data lines DL1, . . . , DLj, . . . , DLq using the grayscales and control signals received from the timing controller 11. The data driver 12 may sample grayscales using a clock signal and apply data voltages corresponding to the grayscales to data lines in units of pixel row. q may be an integer greater than 2, and j may be an integer greater than 1 and less than q. The magnitude of the data voltages may change based on the corresponding grayscale. The data voltages may include black data voltage. The black data voltage may be a data voltage that is to be written to (in some cases, must be written to) the pixel when the pixel displays a black image. For example, the black data voltage may correspond to the minimum grayscale (e.g., 0 grayscale).

The magnitude of the data voltages may change based on the maximum luminance of the display device 10. The maximum luminance may be the luminance of light emitted from pixels set to the maximum grayscale (e.g., 255 grayscales when expressing grayscales in 8 bits). For example, the maximum luminance may be the luminance of white light generated when all pixels of the pixel unit 14 emit light corresponding to a white grayscale. The unit of luminance may be nits. The maximum luminance may also be referred to as display brightness value. This maximum luminance may be set manually by the user's manipulation of the display device 10, or may be set automatically by an algorithm linked to an illuminance sensor, another sensor, or the like. For example, the maximum value of maximum luminance may be 2175 nits, and the minimum value of maximum luminance may be 4 nits. The maximum and minimum values of the maximum luminance may be set in various ways based on the product. Even if the grayscale is the same, the data voltage changes based on the maximum luminance, so the luminance of the pixel also changes.

The scan driver 13 may include first to fourth scan drivers 13GW, 13GB, 13GI, and 13GC. The first scan driver 13GW may provide first scan signals to the first scan lines GW1, . . . , GWi, . . . , and GWp. p may be an integer greater than 2, and i may be an integer greater than 1 and less than p. The second scan driver 13GB may provide second scan signals to the second scan lines GB1, . . . , GBi, . . . , and GBp. The third scan driver 13GI may provide third scan signals to the third scan lines GI1, . . . , GIi, . . . , and GIp. The fourth scan driver 13GC may provide fourth scan signals to the fourth scan lines GC1, . . . , GCi, . . . , GCp.

For example, the first scan driver 13GW may receive at least one scan clock signal and scan start signal from the timing controller 11 and may generate first scan signals to be provided to the first scan lines GW1 to GWp. The first scan driver 13GW may sequentially provide the first scan signals having a turn-on level pulse to the first scan lines GW1 to GWp. For example, the first scan driver 13GW may be configured in the form of a shift register, and may generate the first scan signals in a manner that sequentially transmits the scan start signal, which is a turn-on level pulse type, to the next scan stage based on a control of the scan clock signal.

Each of the second scan driver 13GB, the third scan driver 13GI, and the fourth scan driver 13GC may be configured similarly to the first scan driver 13GW, so duplicate descriptions will be omitted. According to the embodiment, at least some of the first to fourth scan drivers 13GW, 13GB, 13GI, and 13GC may be integrated. In an example in which the polarity and width of the pulses are the same, two or more scan drivers may be integrated.

In an embodiment, the scan driver 13 may generate scan signals using the first gate voltage VGL1 and the second gate voltage VGL2. For example, the turn-on level of the scan signals generated by the first scan driver 13GW and the second scan driver 13GB may be the same as the first gate voltage VGL1. For example, the turn-off level of the scan signals generated by the third scan driver 13GI and the fourth scan driver 13GC may be the same as the second gate voltage VGL2.

The light emitting driver 15 may receive at least one light emitting clock signal and light emitting stop signal from the timing controller 11 and may generate light emitting signals to be provided to the light emitting lines EM1, . . . , EMi, . . . , and EMp. The light emitting driver 15 may sequentially provide the light emitting signals having a turn-off level pulse to the light emitting lines EM1 to EMp. For example, the light emitting driver 15 may be configured in the form of a shift register, and may generate the light emitting signals in a manner that sequentially transmits the light emitting stop signal, which is a turn-off level pulse type, to the next light emitting stage based on a control of the light emitting clock signal.

In FIG. 1, the number of each of the first scan lines (GW1 to GWp), the second scan lines (GB1 to GBp), the third scan lines (GI1 to GIp), the fourth scan lines (GC1 to GCp), and the light emitting lines (EM1 to EMp) may be illustrated as p. However, in another embodiment, the number of at least one of the second scan lines (GB1 to GBp), the third scan lines (GI1 to GIp), the fourth scan lines (GC1 to GCp), and the light emitting lines (EM1 to EMp) may be p/2 or less. For example, two adjacent pixel rows may share one second scan line. Similarly, two adjacent pixel rows may share one third scan line, fourth scan line, or light emitting line. The same pixel row refers to pixels connected to the same first scan line.

The pixel unit 14 (or display panel) includes pixels. Each pixel PXij may be connected to a corresponding data line DLj, scan lines GWi, GBi, GIi, and GCi, and light emitting line EMi. Each pixel PXij may include a light emitting element that emits light based on the received data voltage.

The pixel unit 14 may include first pixels that emit light of a first color, second pixels that emit light of a second color, and third pixels that emit light of a third color. The first color, second color, and third color may be different colors. For example, the first color may be one of red, green, and blue, the second color may be one color other than the first color among red, green, and blue, and the third color may be other color other than the first color and the second color among red, green, and blue. In some aspects, magenta, cyan, and yellow may be used as the first to third colors instead of red, green, and blue. Hereinafter, for convenience of description, it is assumed that the first color is red, the second color is green, and the third color is blue.

The pixel unit 14 may be disposed as various shapes such as, for example, diamond PENTILETM, RGB-Stripe, S-stripe, Real RGB, normal PENTILETM, and the like.

The power supply unit 16 may provide power voltages that are commonly supplied to the pixels of the pixel unit 14. For example, the power supply unit 16 may supply a first power voltage VSS, a second power voltage VDD, an initialization voltage VINT, an anode initialization voltage VAINT, and a bias voltage VOBS to the pixel unit 14. In some aspects, the power supply unit 16 may provide power voltages to the scan driver 13. For example, the power supply unit 16 may provide the first gate voltage VGL1 and the second gate voltage VGL2 to the scan driver 13. For example, the power supply unit 16 may be a power management integrated circuit (PMIC). For example, the power supply unit 16 may be composed of a plurality of DC-DC converters.

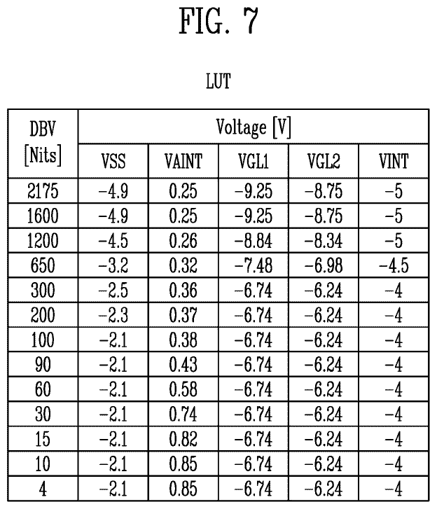

In an embodiment, the power supply unit 16 may change step by step the power voltages provided to the pixel unit 14 and the scan driver 13 based on the display brightness value DBV. In this case, power consumption of the display device 10 may be reduced. Details on changing the power voltages based on the display brightness value DBV will be described later with reference to FIG. 7.

According to the embodiment, the timing controller 11 and the data driver 12 may be configured as one integrated circuit. In some aspects, the timing controller 11, the data driver 12, and the power supply unit 16 may be configured as one integrated circuit. In some aspects, the timing controller 11, the data driver 12, the power supply unit 16, the scan driver 13, and the light emitting driver 15 may be configured as one integrated circuit. Accordingly, for example, the integrated or separate configuration of each component may be determined in various ways based on the product.

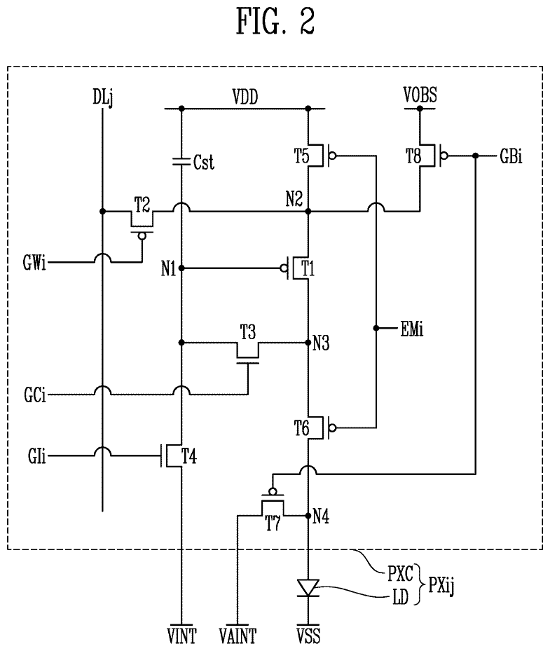

FIG. 2 is a circuit diagram illustrating an embodiment of a pixel included in a display device of FIG. 1.

Referring to FIG. 2, the pixel PXij may include a pixel circuit PXC and a light emitting element LD. The pixel circuit PXC may include transistors T1, T2, T3, T4, T5, T6, T7, and T8, and a storage capacitor Cst.

The pixel PXij may be disposed in the i-th pixel row and in the j-th pixel column. The pixel PXij may be a first pixel for expressing the first color. Since the second pixel for expressing the second color and the third pixel for expressing the third color may be configured the same as the first pixel, duplicate descriptions will be omitted.

P-type transistors may be polysilicon semiconductor transistors. In a polysilicon semiconductor transistor, the channel of the active layer may include a polysilicon semiconductor. For example, the poly-silicon semiconductor transistor may be a low temperature poly-silicon (LTPS) thin film transistor. Polysilicon semiconductor transistors have high electron mobility and thus have fast driving characteristics.

N-type transistors may be oxide semiconductor transistors. In an oxide semiconductor transistor, the channel of the active layer may include an oxide semiconductor. For example, the oxide transistor may be a low temperature polycrystalline oxide (LTPO) thin film transistor. Oxide semiconductor transistors have lower charge mobility than polysilicon semiconductor transistors. Accordingly, the amount of leakage current generated in the turn-off state of oxide semiconductor transistors may be smaller than the amount of leakage current generated in the turn-off state of polysilicon semiconductor transistors.

The first transistor T1 may include a gate electrode connected to a first node N1, a first electrode connected to a second node N2, and a second electrode connected to a third node N3. The first transistor T1 may be a driving transistor. The first transistor T1 may be a P-type transistor.

The second transistor T2 may have a gate electrode connected to the first scan line GWi, a first electrode connected to the data line DLj, and a second electrode connected to the second node N2. The second transistor T2 may be a switching transistor. The second transistor T2 may be a P-type transistor.

The first scan driver 13GW may provide a first scan signal at a turn-on level that determines time when the pixel PXij receives the data voltage. For example, the second transistor T2, which receives the first scan signal at the turn-on level, may be turned on, and the second transistor T2 may apply the data voltage applied to the data line DLj to the second node N2.

The third transistor T3 may have a gate electrode connected to the fourth scan line GCi, a first electrode connected to the first node N1, and a second electrode connected to the third node N3. The third transistor T3 may be a diode-connected transistor. The third transistor T3 may be an N-type transistor.

The fourth transistor T4 may have a gate electrode connected to the third scan line GIi, a first electrode connected to the first node N1, and a second electrode receiving the initialization voltage VINT. The fourth transistor T4 may be a gate initialization transistor. The fourth transistor T4 may be an N-type transistor.

The fifth transistor T5 may have a gate electrode connected to the light emitting line EMi, a first electrode receiving the second power voltage VDD, and a second electrode connected to the second node N2. The fifth transistor T5 may be the first light emitting control transistor. The fifth transistor T5 may be a P-type transistor.

The sixth transistor T6 may have a gate electrode connected to the light emitting line EMi, a first electrode connected to the third node N3, and a second electrode connected to the fourth node N4. The sixth transistor T6 may be a second light emitting control transistor. The sixth transistor T6 may be a P-type transistor.

The seventh transistor T7 may have a gate electrode connected to the second scan line GBi, a first electrode receiving the anode initialization voltage VAINT, and a second electrode connected to the fourth node N4. The seventh transistor T7 may be an anode initialization transistor. The seventh transistor T7 may be a P-type transistor. The magnitude of the anode initialization voltage VAINT may be different from the magnitude of the initialization voltage VINT.

The anode initialization voltage VAINT may be set differently based on the type of light emitting element LD. There is a difference in emission start time based on the type of light emitting element LD, and color drag phenomenon may occur due to the difference in emission start time. For example, the magnitude of the anode initialization voltage VAINT for a first color light emitting element LD, the magnitude of the anode initialization voltage VAINT for a second color light emitting element LD, and the magnitude of the anode initialization voltage VAINT for a third color light emitting element LD may be set to be different from each other. In another embodiment, the anode initialization voltages VAINT for the two color light emitting elements LD may be set to be the same, and the anode initialization voltages VAINT for the remaining one color light emitting elements LD may be set differently. In another embodiment, the anode initialization voltages VAINT for all light emitting elements LD may be set to be the same. The setting of the anode initialization voltage VAINT as described herein may prevent color drag phenomenon by adjusting the difference in the emission start time of the light emitting elements LD for each color.

The second scan driver 13GB may provide a second scan signal at a turn-on level that determines time for initializing the anode voltage of the light emitting element LD. For example, the seventh transistor T7, which receives the second scan signal at the turn-on level, may be turned on, and the anode initialization voltage VAINT may be applied to the anode of the light emitting element LD, so the anode voltage of the light emitting element LD may be initialized to the anode initialization voltage VAINT.

The eighth transistor T8 may have a gate electrode connected to the second scan line GBi, a first electrode receiving the bias voltage VOBS, and a second electrode connected to the second node N2. The eighth transistor T8 may be a bias transistor. The eighth transistor T8 may be a P-type transistor.

The storage capacitor Cst may have a first electrode receiving the second power voltage VDD, and a second electrode connected to the first node N1.

The anode of the light emitting element LD may be connected to the fourth node N4, and the cathode of the light emitting element LD may receive the first power voltage VSS. The light emitting element LD may emit light in one of a first color, a second color, and a third color. The light emitting element LD may be a light emitting diode. The light emitting element LD may include an organic light emitting diode, an inorganic light emitting diode, a quantum dot/well light emitting diode, or the like. In this embodiment, each pixel may include one light emitting element LD, but in other embodiments, each pixel may include a plurality of light emitting elements. In this case, the plurality of light emitting elements may be connected in series, parallel, series-parallel, or the like.

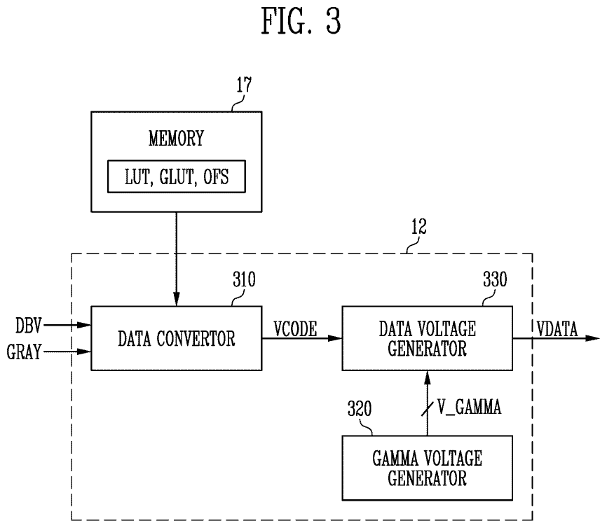

FIG. 3 is a block diagram illustrating an embodiment of a data driver included in a display device of FIG. 1. For convenience of description, a memory 17 (or memory device) may be further illustrated in FIG. 3.

Referring to FIGS. 1 and 3, the data driver 12 may include a data converter 310, a gamma voltage generator 320, and a data voltage generator 330.

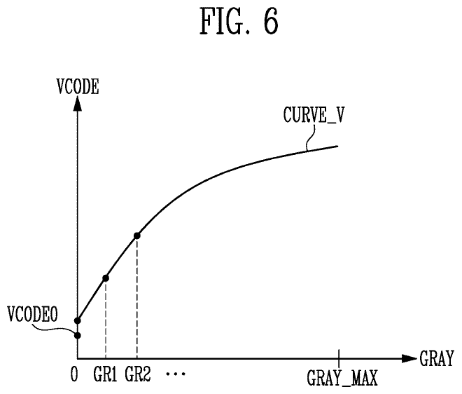

The data converter 310 may convert a grayscale GRAY into a voltage value VCODE (or voltage code) using a gamma lookup table GLUT. Here, the gamma lookup table GLUT may include a voltage value VCODE (or gamma voltage value) corresponding to the grayscale GRAY, and the gamma lookup table GLUT may be provided to the data converter 310 from the memory 17. The voltage value VCODE may include information on one of gamma voltages V_GAMMA generated by the gamma voltage generator 320. For example, the voltage value VCODE may be a data value of a voltage domain. For example, a relationship between the grayscale GRAY and the voltage value VCODE may correspond to or coincide with a 2.2 gamma curve. The voltage value VCODE will be described later with reference to FIG. 6.

In an embodiment, the data converter 310 may calculate a gamma lookup table (hereinafter referred to as an “intermediate lookup table”) corresponding to the display brightness value DBV from the gamma lookup table GLUT. In some cases, due to capacity limitations of the memory 17, the gamma lookup table GLUT may be preset for some display brightness values among an entire range of the display brightness values DBV. In this case, the data converter 310 may calculate (e.g., interpolate) the gamma lookup table GLUT based on the display brightness value DBV to calculate the intermediate lookup table corresponding to the display brightness value DBV.

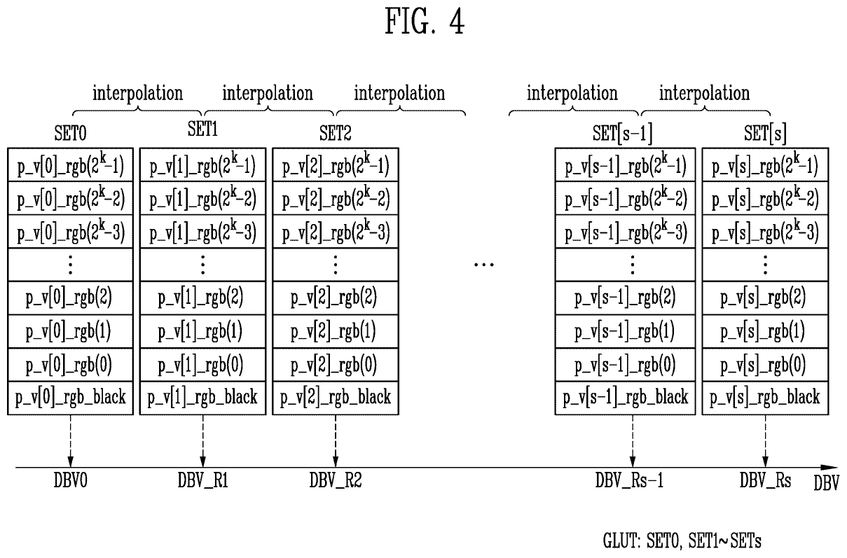

In an embodiment, the data converter 310 may calculate or corrects (or updates) an offset OFS for the display brightness value DBV, and may reflect the offset OFS into the intermediate lookup corresponding to the display brightness value DBV. For example, the offset OFS may be added to the voltage value in the intermediate lookup table. In order to minimize a size of the hardware and a computational load, the data converter 310 may obtain the intermediate lookup table through a simple calculation (e.g., linear interpolation rather than non-linear interpolation). In this case, there may be an error between the intermediate lookup table and a target gamma lookup table (i.e., gamma lookup table that satisfies conditions based on the display brightness value DBV). Accordingly, the data converter 310 may compensate for the intermediate lookup table using the offset OFS. More specific operations of the data converter 310 will be described later with reference to FIGS. 4 to 6.

The data converter 310 may convert the grayscale GRAY into the voltage value VCODE using the compensated intermediate lookup table.

The gamma voltage generator 320 may generate gamma voltages V_GAMMA having a linear relationship. For example, the gamma voltage generator 320 may include a resistor string and gamma buffers that transfers reference gamma voltages to taps (or tap points) of the resistor string. For example, the gamma voltage generator 320 may be implemented as an analog gamma integrated circuit.

The data voltage generator 330 may generate the data voltage VDATA based on the voltage value VCODE and the gamma voltages V_GAMMA. For example, the data voltage generator 330 may include a shift register, a latch, a decoder, an output buffer, or other components supportive of features of the data voltage generator 330, and the data voltage generator 330 may sequentially provide or temporarily store the voltage value VCODE to the shift register and the latch. Alternatively, the data voltage generator 330 may select the gamma voltage corresponding to the voltage value VCODE among the gamma voltages V_GAMMA through the decoder, and may output the selected gamma voltage as the data voltage VDATA through the output buffer.

The memory 17 may store the gamma lookup table GLUT and the offset OFS. For example, the memory 17 may be implemented as a flash memory, may be mounted on a flexible circuit board on which the data driver 12 is mounted, and may be connected to the data driver 12 (e.g., data converter 310).

In some aspects, the memory 17 may store a lookup table LUT. The lookup table LUT may include voltage levels (or voltage values) of power voltages corresponding to the display brightness value DBV, and may be provided to the power supply unit 16 of FIG. 1. In this case, the power supply unit 16 may change the power voltages using the lookup table LUT.

As described herein, the data driver 12 may convert the grayscale GRAY into the voltage value VCODE on a 2.2 gamma curve using the gamma lookup table GLUT, and may output the gamma voltage corresponding to the voltage value VCODE among the gamma voltages V_GAMMA that have a linear relationship with each other, as the data voltage VDATA. That is, instead of generating the gamma voltages corresponding to the 2.2 gamma curve, the display device 10 may use a method that converts the grayscale GRAY to the voltage value VCODE using the gamma lookup table LUT that includes the relationship between the grayscale GRAY and the voltage value VCODE preset based on the 2.2 gamma curve.

In some embodiments, the data driver 12 has been described as including the data converter 310, the gamma voltage generator 320, and the data voltage generator 330. However, for example, at least one of the data converter 310, the gamma voltage generator 320, and the data voltage generator 330 may be implemented as an independent integrated circuit.

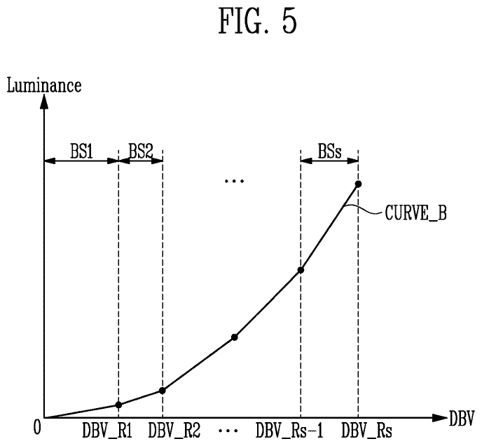

FIG. 4 is a drawing illustrating an embodiment of a gamma lookup table used in a data converter of FIG. 3. FIG. 5 is a graph illustrating a relationship between a display brightness value and luminance. FIG. 6 is a graph illustrating a relationship between grayscales and voltage values.

Referring to FIGS. 3 to 6, the data converter 310 may calculate the intermediate lookup table corresponding to the display brightness value DBV from the gamma lookup table GLUT.

When the gamma lookup table GLUT for the display brightness value DBV is previously stored, the gamma lookup table GLUT may be selected. In contrast, when the gamma lookup table GLUT for the display brightness value DBV is not previously stored, the intermediate lookup table may be calculated from the gamma lookup table GLUT.

In an embodiment, the data converter 310 may select two gamma lookup tables from the gamma lookup table GLUT based on the display brightness value DBV, and may calculated the intermediate lookup table by linearly interpolating the two gamma lookup tables. The two gamma lookup tables may be gamma lookup tables GLUT for two representative brightness values (or representative display brightness values) adjacent to the display brightness value DBV among the preset representative lookup tables SET0 and SET1˜SET[s] (see FIG. 3).

Referring to FIG. 4, the gamma lookup table GLUT may include representative lookup tables SET0 and SET1 to SET[s] preset for representative brightness values DBV0 and DBV_R1 to DBV_Rs. s may be a positive integer. Considering the size limitations of the memory 17, in some cases, the representative lookup tables SET0 and SET1˜SET[s] may be set only for the representative brightness values DBV0 and DBV_R1˜DBV_Rs included in the range of the display brightness values DBV.

For example, the reference lookup table SET0 may be set to correspond to the reference luminance value DBV0 (e.g., 0 nit). According to the embodiment, the reference lookup table SET0 may be omitted. For example, the first representative lookup table SET1 may be set to correspond to the first representative brightness value DBV_R1 (e.g., 17 nits), the second representative lookup table SET2 may be set to correspond to the second representative brightness value DBV_R2 (e.g., 17 nits), the s-1-th representative lookup table SET[s-1] may be set correspond to the s-1-th representative brightness value DBV_Rs-1, and the s-th representative lookup table SET[s] may be set to correspond to the s-th representative brightness value DBV_Rs.

Each of the representative brightness values DBV0 and DBV_R1 to DBV_Rs may be an arbitrary value. Referring to FIG. 5, for example, the luminance curve CURVE_B representing the luminance of the display device 10 based on the display brightness value DBV may be expressed as a non-linear curve, and the representative brightness values DBV0 and DBV_R1 to DBV_Rs may correspond to inflection points of the luminance curve CURVE_B, but is not limited thereto. The display brightness value DBV (or range of the display brightness value DBV) may be divided into brightness sections BS1 to BSs (or luminance sections) by the representative brightness values DBV0 and DBV_R1 to DBV_Rs.

Referring again to FIG. 4, the gamma lookup table GLUT may include voltage values for at least some of all grayscales. For example, considering the size limitation of the memory 17, in some aspects, only voltage values for the representative grayscales 0, GR1, and GR2, which are some of all grayscales, may be included in the gamma lookup table GLUT, but is not limited thereto. Referring to FIG. 6, for example, the voltage value curve (CURVE_V) representing the voltage value based on the grayscale GRAY may be expressed as a non-linear curve, and the representative grayscales 0, GR1, and GR2 may correspond to inflection points of the voltage value curve CURVE_V, but is not limited thereto. The black voltage value VCODE0 may be a voltage value for black grayscale.

For example, in the s-th representative lookup table SET[s], a black voltage value (p_v[s]_rgb_black) may be a voltage value for the black grayscale corresponding to black, a reference voltage value (p_v[s]_rgb(0)) may be a voltage value for a grayscale of 0, a first voltage value (p_v[s]_rgb(1)) may be a voltage value for the first representative grayscale, a second voltage value (p_v[s]_rgb(2)) may be a voltage value for the second representative grayscale, and the 2k-1-th voltage value (p_v[s]_rgb(k)) may be a voltage value for the 2k-1-th representative grayscale. Since the voltage values of the representative lookup tables SET0 and SET1 to SET[s] are as illustrated in FIG. 4, descriptions of the voltage values will be omitted.

In an embodiment, the data converter 310 may calculate the gamma lookup table for the display brightness value DBV (or intermediate brightness value) between the representative brightness values DBV0 and DBV_R1 to DBV_Rs by interpolating the representative lookup tables SET0 and SET1 to SET[s]. To simplify the calculation, the data converter 310 may calculate the gamma lookup table for the display brightness value DBV (or intermediate brightness value) by linearly interpolating the representative lookup tables SET0 and SET1 to SET[s].

For example, the gamma lookup table for the display brightness value DBV between the first representative brightness value DBV_R1 and the second representative brightness value DBV_R2 may be calculated by linearly interpolating the first representative lookup table SET1 and the second representative lookup table SET2. For example, by linearly interpolating the first voltage value (p_v[1]_rgb(1)) of the first representative lookup table SET1 and the first voltage value (p_v[1]_rgb(1)) of the second representative lookup table SET2, the first voltage value of the gamma lookup table for the display brightness value DBV may be calculated. Accordingly, for example, each voltage value in the lookup table for the display brightness value DBV may be calculated.

However, since ideal luminance of the display device 10 based on the display brightness value DBV does not change linearly, an error may occur between actual luminance of the display device using only linear interpolation and the ideal luminance of the display device 10. Accordingly, the data converter 310 may reflect the offset OFS (see FIG. 3) corresponding to the display brightness value DBV in the gamma lookup table calculated through the interpolation. The offset OFS may be preset for at least some of the entire range of the display brightness values DBV. For example, the offset may be derived through a multi-time programming (MTP) process. For example, by repeating a process of measuring the luminance of the image displayed on the display device 10 (see FIG. 1) and adjusting a voltage value corresponding to an arbitrary grayscale (e.g., maximum grayscale, or white grayscale), the offset may be derived. Each offset may be or correspond to a difference between a measured value (i.e., a voltage value obtained through measurement) and a linear calculation value (i.e., a voltage value calculated through linear calculation).

FIG. 7 is a drawing illustrating an example of a lookup table used in a power supply unit of FIG. 1.

Referring to FIG. 7, the lookup table LUT may include voltage levels (or voltage values) of power voltages corresponding to the display brightness value DBV.

For example, the lookup table LUT may include each voltage level (or voltage value) of the first power voltage VSS, the anode initialization voltage VAINT, the first gate voltage VGL1, the second gate voltage VGL2, and the initialization voltage VINT based on 13 representative brightness values. As illustrated in FIG. 7, the minimum value among the representative brightness values may be 4 nits, and the maximum value among the representative brightness values may be 2175 nits, but this is an example and the representative brightness values are not limited thereto.

Since the voltage levels (or voltage values) of the power voltages based on each representative brightness value are as illustrated in FIG. 7, descriptions of the voltage levels will be omitted. The voltage levels illustrated in FIG. 7 are examples and the voltage levels are not limited thereto.

In an embodiment, the power supply unit 16 (see FIG. 1) may calculate (e.g., interpolate) the power voltages in the lookup table LUT based on the display brightness value DBV, and may generate the power voltage corresponding to the display brightness value DBV (i.e., display brightness value DBV other than the representative brightness values).

In an example in which the display brightness value DBV is 150 nits, the power supply unit 16 may determine a voltage value of the first power voltage VSS corresponding to 150 nits by interpolating −2.10V, which is a voltage value of the first power voltage VSS at 100 nits, and −2.30V, which is a voltage value of the first power voltage VSS at 200 nits, and may generate the first power voltage VSS having a voltage level corresponding to the determined voltage value. In a similar manner, the first power voltage VSS over the entire range of the display brightness values DBV may be generated. In some aspects, similar to the method of generating the first power voltage VSS, the power supply unit 16 may generate the anode initialization voltage VAINT, the first gate voltage VGL1, the second gate voltage VGL2, and the initialization voltage VINT corresponding to the display brightness value DBV.

In contrast, for example, unlike the gamma voltage generator 320 (see FIG. 3) that generates gamma voltages using the resistor string, the power supply unit 16 may adjust the power voltage through the on/off operation of a transistor, such that the power supply unit 16 cannot finely adjust the power voltage. For example, the power supply unit 16 may adjust the first power voltage VSS in units of 0.05V. Accordingly, the power voltage may change step by step (or with steps) based on the display brightness value DBV.

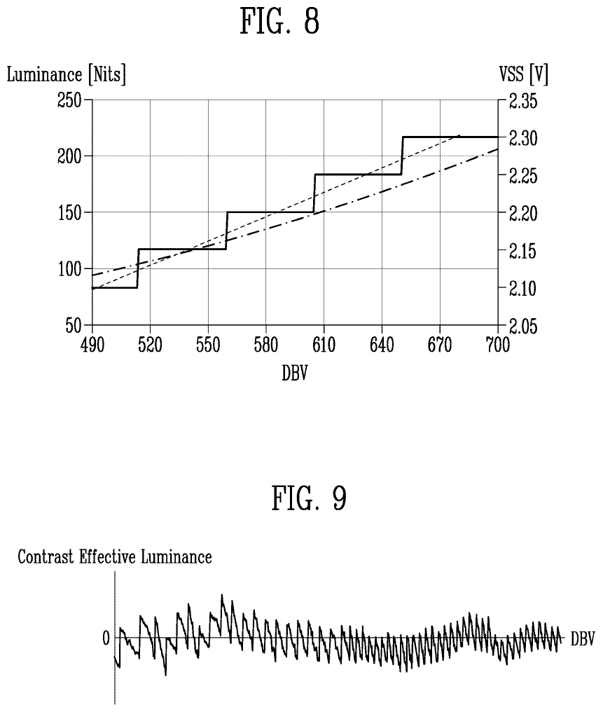

FIG. 8 is a drawing illustrating a first power voltage based on a display brightness value. FIG. 9 is a drawing illustrating contrast effective luminance based on a display brightness value.

First, referring to FIG. 8, when an image of a specific grayscale is displayed while the display brightness value DBV is changed between 490 and 700, the luminance of the image may change linearly between about 100 nits and 200 nits.

The first power voltage VSS may change step by step based on the display brightness value DBV. The first power voltage VSS does not change linearly along a dotted line, but may change step by step. For example, the first power voltage VSS may change step by step in units of 0.05V. For example, the magnitude of the first power voltage VSS may change from 2.10V to 2.15V at a display brightness value of 514 (DBV514), the magnitude of the first power voltage VSS may change from 2.15V to 2.20V at a display brightness value of 560 (DBV560), the magnitude of the first power voltage VSS may changes from 2.20V to 2.25V at a display brightness value of 605 (DBV605), and the magnitude of the first power voltage VSS may change from 2.25V to 2.30V at a display brightness value of 651 (DBV651) of 651.

The first power voltage VSS (and/or other power voltages) that changes step by step based on the display brightness value DBV may affect the contrast effective luminance (CEL) of the display device.

The contrast effective luminance may represent a luminance error between the specific luminance and the actual luminance when displaying an image of a specific luminance while changing the display brightness value DBV (and grayscale). For example, as illustrated in FIG. 9, as the display brightness value DBV changes, the contrast effective luminance changes, and in particular, a peak repeatedly occurs in the contrast effective luminance. Experimentally, it was confirmed that the peak of contrast effective luminance occurs at the display brightness value DBV where a step of the first power voltage VSS occurs.

Therefore, the data driver 12 (and the display device 10) according to an embodiment of the present invention may sense the display brightness value DBV at which a step occurs in the power voltage, may set or correct an offset to reduce the luminance error based on the display brightness value DBV, may generate or correct gamma voltages based on the offset, and may generate a data voltage based on the corrected gamma voltages. In this case, the contrast effective luminance (or luminance error) can be reduced, and the display quality of the display device can be improved.

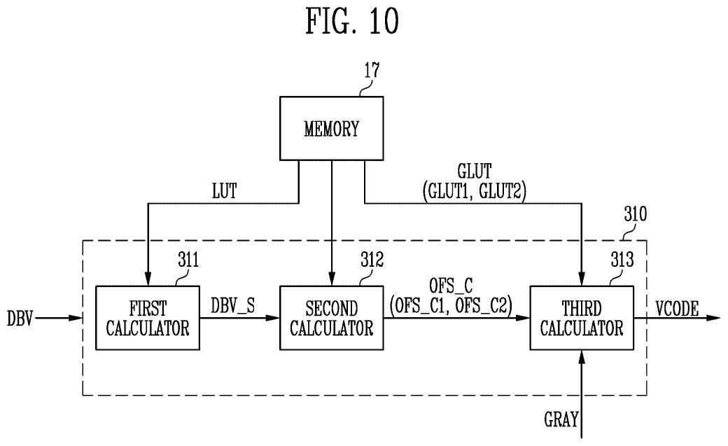

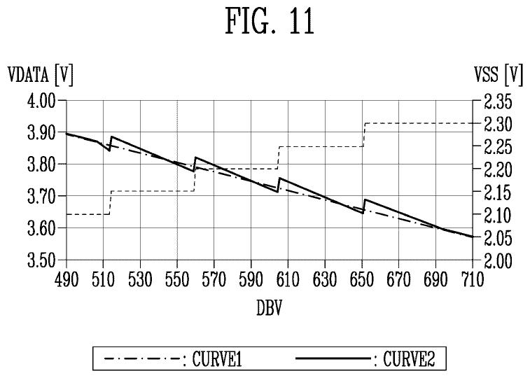

FIG. 10 is a block diagram illustrating an embodiment of a data converter of FIG. 3. For convenience of description, a memory 17 may be further illustrated in FIG. 10. FIG. 11 is a drawing illustrating a data voltage and a first power voltage based on a display brightness value. FIG. 11 illustrates the data voltage VDATA based on the display brightness value DBV for displaying an image of a specific grayscale. Hereinafter, the embodiment of FIGS. 10 and 11 will be described based on the first power voltage VSS among the power voltages of FIGS. 1 and 7.

Referring to FIGS. 3 and 8 to 10, the data converter 310 may include a first calculator 311, a second calculator 312, and a third calculator 313.

The first calculator 311 may sense the first display brightness value DBV_S (or display brightness value point) at which a step occurs in the first power voltage VSS.

In an embodiment, the first calculator 311 may determine the voltage level at each step of the first power voltage VSS based on the lookup table LUT, and may determine the first display brightness value DBV_S based on the voltage level at each step. For example, with reference to FIG. 8, the first calculator 311 may determine steps of 2.15V, 2.20V, 2.25V, 2.30V, and the like based on values of the first power voltage VSS in the lookup table LUT and the minimum variation width (e.g., 0.05V) of the first power voltage VSS, and may determine the display brightness value (DBV514, DBV560, DBV605, DBV651, and the like), which is a starting point of each step, as the first display brightness value DBV_S.

The second calculator 312 may set or correct the offset OFS based on the first display brightness value DBV_S or may generate the corrected offset OFS_C.

In an embodiment, the second calculator 312 may set the first offset OFS_C1 for the first display brightness value DBV_S corresponding to the starting point of the step, and may set the second offset OFS_C2 for the second display brightness value corresponding to the last point (or ending point) of the step. For example, the second display brightness value may be 513, 559, 604, 650, and the like. That is, the second display brightness value may be a display brightness value smaller than the first display brightness value DBV_S by one, but is not limited thereto.

In an embodiment, the second calculator 312 may set or correct the first offset OFS_C1 for the first display brightness value DBV_S such that the luminance of the display device is lowered within a correction range, or may set or correct the second offset OFS_C2 for the second display brightness value such that the luminance is higher within the correction range. As previously described with reference to FIG. 9, a peak in the contrast effective luminance occurs at the point where the step of the first power voltage VSS occurs (i.e., the luminance is high), so the first offset OFS_C1 for the first display brightness value DBV_S may be corrected to lower the luminance. Since the luminance is low just before the point where the step of the first power voltage VSS occurs, the second offset OFS_C2 for the second display brightness value may be corrected to higher the luminance.

The correction range may be the same as or correspond to the range of the contrast effective luminance in FIG. 9. For example, the correction range may be ±3%. In an embodiment, the correction range may be set to be the same at each step of the first power voltage VSS. In another embodiment, the entire range of the display brightness values DBV may be divided into display brightness value sections, and the correction range may be set differently for each display brightness value section. The display brightness value sections may correspond to at least one of the steps of the first power voltage VSS. For example, the display brightness value sections may be the brightness sections BS1 to BSs described with reference to FIG. 5. In another example, the display brightness value sections may respectively correspond to steps of the first power voltage VSS. As illustrated in FIG. 9, a range of the contrast effective luminance may change based on the display brightness value DBV, and in consideration of the display brightness value DBV, the correction range may be set differently for each display brightness value section. For example, in sections where the display brightness value DBV is small, the correction range may be set to be larger (or the offset may be weighted), and in sections where the display brightness value DBV is large, the correction range may be set to be smaller. In other words, the offset OFS_C may be set by assigning weight to each display brightness value section.

In an embodiment, the offset OFS_C may be set to change linearly based on the display brightness value DBV between the first display brightness value DBV_S and the second display brightness value. For example, the second calculator 312 may set the offset OFS_C of the display brightness value DBV by interpolating the first offset OFS_C1 and the second offset OFS_C2.

The third calculator 313 may correct the gamma lookup table GLUT using the offset OFS_C. The third calculator 313 may correct gamma voltage values (or voltage values) in the gamma lookup table GLUT using the offset OFS_C. The third calculator 313 may convert the grayscale GRAY into the voltage value VCODE using the corrected gamma lookup table (or corrected gamma voltage values).

In an embodiment, the third calculator 313 may calculate first gamma voltage values based on the first gamma lookup table GLUT1 corresponding to the first display brightness value DBV_S, may calculate second gamma voltage values based on the second gamma lookup table GLUT2 corresponding to the second display brightness value, may correct the first gamma voltage values based on the first offset OFS_C1, may correct the second gamma voltage values based on the second offset OFS_C2, may interpolate the corrected first and second gamma voltage values, and may calculate, based on the interpolation, gamma voltage values based on the display brightness value DBV. Here, at least one of the first gamma lookup table GLUT1 and the second gamma lookup table GLUT2 may be obtained from the gamma lookup table GLUT or may be obtained through the interpolation operation described with reference to FIG. 4. For example, the third calculator 313 may correct the first gamma lookup table GLUT1 (or first gamma voltage values) using the first offset OFS_C1, may correct the second gamma lookup table GLUT2 (or second gamma voltage values) using the second offset OFS_C2, and may interpolate the corrected first and second gamma lookup tables to obtain the gamma lookup table based on the display brightness value DBV. That is, after a correction operation using the offset OFS_C, an interpolation operation may be performed. To this end, the first offset OFS_C1 and the second offset OFS_C2 may be set, and offsets for display brightness values other than the first and second display brightness values may not be set.

In another embodiment, the third calculator 313 may obtain the gamma lookup table for the display brightness value DBV using the gamma lookup table GLUT for representative brightness values, and may correct the obtained gamma lookup table using the offset OFS_C. For example, the third calculator 313 may interpolate gamma voltage values in the gamma lookup table GLUT for representative brightness values to obtain gamma voltage values for the display brightness value DBV, and may reflect the offset OFS_C in the obtained gamma voltage value. That is, after the interpolation operation, a correction operation using the offset OFS_C may be performed.

Referring to FIGS. 8, 10, and 11, the first curve CURVE1 (or the first graph) may represent a data voltage VDATA based on the display brightness value DBV when the offset OFS_C is not applied, and the second curve CURVE2 (or the second graph) may represent a data voltage VDATA (i.e., the data voltage VDATA based on the data value DCODE) based on the display brightness value DBV when the offset OFS_C is applied.

When the offset OFS_C is not applied, the data voltage VDATA may change linearly based on the display brightness value DBV. In an example in which the first transistor T1 of FIG. 2 is implemented as a P-type transistor, the data voltage VDATA may linearly decrease as the display brightness value DBV increases.

When the offset OFS_C is applied, the data voltage VDATA may change linearly in the display brightness value DBV where the first power voltage VSS is maintained constant or in a section including the same, but the data voltage VDATA may change non-linearly or discontinuously in the display brightness value DBV where the step of the first power voltage VSS occurs or in a section corresponding thereto. For example, the data voltage VDATA may change with steps at the display brightness value (DBV514, DBV560, DBV605, DBV651, see FIG. 8), which is the starting point of each step of the first power voltage VSS. For example, the data voltage VDATA at a display brightness value of 514 (DBV514) may be greater than the data voltage VDATA at a previous point (e.g., a display brightness value of 513).

As described herein, the first offset OFS_C1 for the starting point of each step of the first power voltage VSS may be set to lower the luminance, and accordingly, the data voltage VDATA at the starting point at which the first offset OFS_C1 is reflected, may be higher than the data voltage VDATA based on the first curve CURVE1. The second offset OFS_C2 for the ending point of each step of the first power voltage VSS may be set to higher the luminance, and accordingly, the data voltage VDATA at the ending point at which the second offset OFS_C2 is reflect, may be lower than the data voltage VDATA based on the first curve CURVE1.

In some embodiments, in FIGS. 10 and 11, although it is described that the data converter 310 corrects the gamma lookup table GLUT (or gamma voltages, data voltage) based on the first power voltage VSS (or a step of the first power voltage VSS), but embodiments of the present disclosure are not limited thereto. For example, the data converter 310 may also correct the gamma lookup table GLUT (or gamma voltages, data voltage) based on other power voltages of FIGS. 1 and 7, for example, the anode initialization voltage VAINT, the first gate voltage VGL1, the second gate voltage VGL2, and/or the initialization voltage VINT instead of the first power voltage VSS.

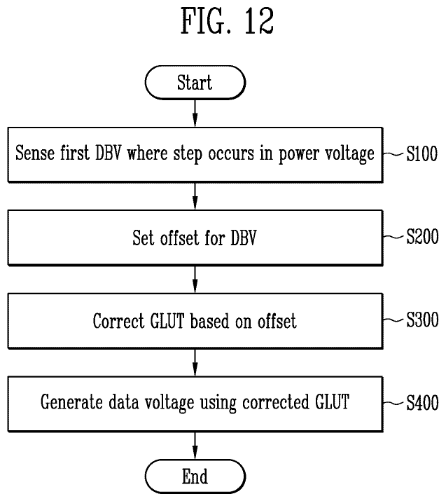

FIG. 12 is a flowchart illustrating a driving method of a display device according to embodiments.

In the descriptions of the method and processes herein, the operations may be performed in a different order than the order shown and/or described, or the operations may be performed in different orders or at different times. Certain operations may also be left out of the flowcharts, one or more operations may be repeated, or other operations may be added. Aspects of the method may be implemented by a display device 10 described herein.

Referring to FIGS. 1 to 12, the method of FIG. 12 may be performed by the display device 10 of FIG. 1. The display device 10 of FIG. 1 may change the power voltage step by step based on the display brightness value DBV and display an image with maximum luminance corresponding to the display brightness value DBV. Here, the power voltage may be one of the first power voltage VSS, the anode initialization voltage VAINT, the first gate voltage VGL1, the second gate voltage VGL2, and the initialization voltage VINT illustrated in FIGS. 1 and 7.

The method of FIG. 12 may include sensing the first display brightness value DBV_S (see FIGS. 8 and 10) where a step occurs in the power voltage (S100).

For example, with reference to FIG. 8, the method of FIG. 12 may include determining the voltage level at each step of the first power voltage VSS based on the lookup table LUT, and the method may include determining the first display brightness value DBV_S based on the voltage level at each step.

Thereafter, the method of FIG. 12 may include setting or correcting the offset OFS_C for the display brightness value DBV based on the first display brightness value DBV_S (S200).

For example, with reference to FIG. 8, the method of FIG. 12 may include setting the first offset OFS_C1 for the first display brightness value DBV_S corresponding to the starting point of the step, and the method may include setting the second offset OFS_C2 for the second display brightness value corresponding to the last point (or ending point) of the step.

In an embodiment, the method of FIG. 12 may include setting or correcting the first offset OFS_C1 for the first display brightness value DBV_S such that the luminance of the display device is lowered within a correction range (i.e., the luminance is a reduced to a luminance value included in the correction range), or may set or correct the second offset OFS_C2 for the second display brightness value such that the luminance is higher within the correction range (i.e., the luminance is a increased to a luminance value included in the correction range). The correction range may be the same as or correspond to the range of the contrast effective luminance in FIG. 9. The method may include setting the correction range to be the same in each step of the first power voltage VSS or the corresponding display brightness value section, or the method may include setting the correction range differently for each display brightness value section.

Thereafter, the method of FIG. 12 may include correcting the gamma lookup table GLUT or gamma voltage values based on the display brightness value DBV based on the offset OFS_C (S300).

Referring to FIG. 10, for example, the method of FIG. 12 may include calculating first gamma voltage values based on the first gamma lookup table GLUT1 corresponding to the first display brightness value DBV_S, calculating second gamma voltage values based on the second gamma lookup table GLUT2 corresponding to the second display brightness value, correcting the first gamma voltage values based on the first offset OFS_C1, correcting the second gamma voltage values based on the second offset OFS_C2, interpolating the corrected first and second gamma voltage values, and calculating, based on the interpolating, gamma voltage values based on the display brightness value DBV.

In another example, the method of FIG. 12 may include setting or correcting the offset OFS_C for the display brightness value DBV based on the first offset OFS_C1 and the second offset OFS_C2, obtaining the gamma lookup table for the display brightness value DBV by using the gamma lookup table GLUT for representative brightness values, and correcting the obtained gamma lookup table using the offset OFS_C.

Thereafter, the method of FIG. 12 may include generating the data voltage VDATA based on the corrected gamma voltage values.

As described with reference to FIG. 11, since the offset OFS_C is applied, the data voltage VDATA may change linearly in the display brightness value DBV (or a first display brightness value) where the power voltage is maintained constant or in a section including the display brightness value DBV (or the first display brightness value), but the data voltage VDATA may change non-linearly or discontinuously in the display brightness value DBV (or a second display brightness value) where the step of the power voltage occurs or in the section including the display brightness value DBV (or the second display brightness value).

A display device according to an embodiment is applicable to various types of electronic devices. In an embodiment, an electronic device includes the above-described display device and may further include other modules or devices having additional functions in addition to the display device.

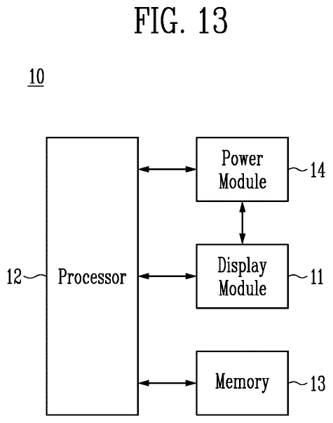

FIG. 13 is a block diagram of an electronic device according to an embodiment. Referring to FIG. 13, the electronic device 10 may include a display module 11, a processor 12, a memory 13, and a power module 14.

The processor 12 may include at least one of a central processing unit (CPU), an application processor (AP), a graphic processing unit (GPU), a communication processor (CP), an image signal processor (ISP), and a controller.

The memory 13 may store data and/or information used to operate the processor 12 or the display module 11. When the processor 12 executes an application stored in the memory 13, image data signals and/or input control signals may be transferred to the display module 11. The display module 11 may process the provided signals and output image information on a display screen.

The power module 14 may include a power supply module, such as a power adapter or a battery device, and a power conversion module. The power conversion module converts power supplied by the power supply module and generates power to operate the electronic device 10.

At least one of the above-described components of the electronic device 10 may be included in the display device according to embodiments as described above. In addition, in terms of functionality, some of the individual modules included in one module may be included in the display device and others may be provided separately from the display device. For example, the display module 11 is included in the display device, whereas the processor 12, the memory 13, and the power module 14 are not included in the display device and are instead provided separately in the electronic device 10.

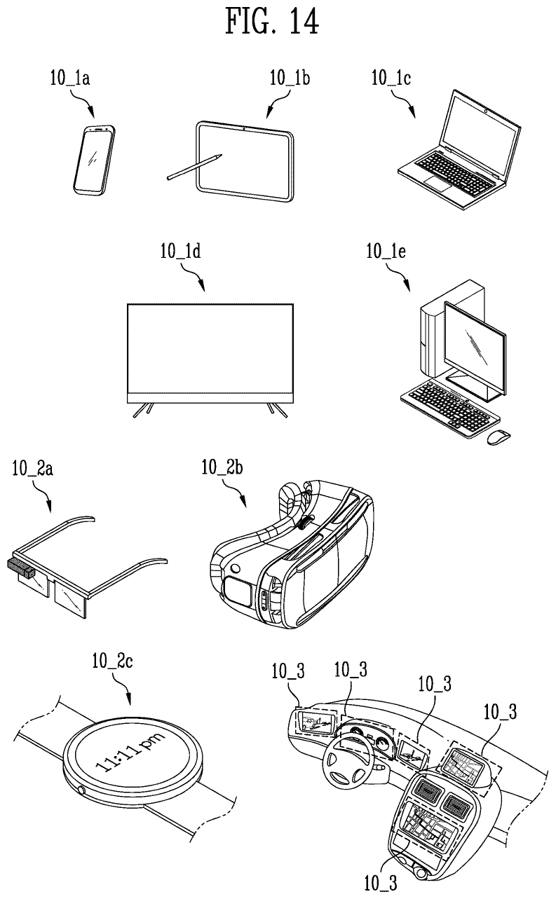

FIG. 14 shows schematic views of various embodiments of an electronic device.

Referring to FIG. 14, various types of electronic devices to which embodiments of a display device are applied may include an electronic device to display images such as a smartphone 10_1a, a tablet PC 10_1b, a laptop computer 10_1c, a television (TV) 10_1d, and a desktop monitor 10_1e, a wearable electronic device including a display module such as smart glasses 10_2a, a head-mounted display (HMD) 10_2b, and a smart watch 10_2c, and an automotive electronic device 10_3 including a display module such as a center information display (CID) disposed at the instrument cluster, the center fascia, and the dashboard of a vehicle, and a room mirror display.

The technical idea of the present disclosure has been specifically described according to the example embodiments, but it should be noted that the foregoing embodiments are provided for illustration while not limiting the present disclosure. In some aspects, it will be understood by those skilled in the art that various changes in form and details may be made therein without departing from the scope of the present invention.

What is claimed is:

1. A driving method of a display device that changes a power voltage step by step based on a display brightness value (DBV) and displays an image with a maximum luminance corresponding to the DBV, the driving method comprising:
sensing a first DBV where a step occurs in the power voltage;
setting an offset for the DBV based on the first DBV;
correcting gamma voltage values based on the DBV based on the offset; and
generating a data voltage based on the corrected gamma voltage values.

2. The driving method of claim 1, further comprising:
setting a voltage level of the power voltage using a lookup table stored in a memory,
wherein the lookup table comprises information on voltage levels of the power voltage based on one or more DBVs within a DBV range.

3. The driving method of claim 2, wherein the sensing the first DBV comprises:
determining a voltage level at each step of the power voltage by interpolating voltage levels in the lookup table, and
determining the first DBV based on the voltage level at the each step.

4. The driving method of claim 1, wherein the setting the offset comprises:
setting a first offset for the first DBV corresponding to a starting point of the step, and
setting a second offset for a second DBV corresponding to an ending point of the step.

5. The driving method of claim 4, wherein:
the first offset is set such that luminance of the display device is lowered within a correction range, and
the second offset is set such that the luminance is higher within the correction range.

6. The driving method of claim 5, further comprising setting the correction range to be the same at each of the steps of the power voltage.

7. The driving method of claim 5, wherein:
a range of the DBV is divided into DBV sections, and each of the DBV sections corresponds to at least one of the steps of the power voltage, and
the correction range is set differently for each DBV section.

8. The driving method of claim 5, wherein:
the gamma lookup table comprises information on gamma voltages based on one or more DBVs within the DBV range and is stored in a memory, and
the correcting the gamma voltage values comprises:
calculating first gamma voltage values for the first DBV and second gamma voltage values for the second DBV based on the gamma lookup table,
correcting the first gamma voltage values for the first DBV and the second gamma voltage values for the second DBV based on the first offset and the second offset, and
interpolating the corrected first gamma voltage values and the corrected second gamma voltage values and calculating, based on the interpolating, gamma voltage values based on the DBV.

9. The driving method of claim 5, wherein setting the offset for the DBV is based on the first offset and the second offset.

10. The driving method of claim 9, wherein:
the gamma lookup table comprises information on gamma voltages based on one or more DBVs within the DBV range and is stored in a memory, and
the correcting the gamma voltage values comprises:
interpolating the gamma voltages based on the one or more DBVs and obtaining, based on the interpolating, the gamma voltage values based on the DBV, and
reflecting the offset in the gamma voltage values based on the DBV.

11. The driving method of claim 1, wherein the data voltage for a first grayscale:
changes linearly based on the DBV in a DBV section in which the power voltage is maintained constant, and
changes nonlinearly or discontinuously in:
a DBV section in which the step of the power voltage occurs; or
the first DBV.

12. The driving method of claim 1, wherein:
the display device comprises a light emitting element, and
the driving method comprises applying the power voltage to a cathode electrode of the light emitting element.

13. The driving method of claim 1, wherein:
the display device comprises a light emitting element and a driving transistor connected to an anode electrode of the light emitting element, and
the driving method comprises applying the power voltage to the anode electrode of the light emitting element.

14. The driving method of claim 1, wherein:
the display device comprises a light emitting element and a driving transistor connected to an anode electrode of the light emitting element, and
the driving method comprises applying the power voltage to a gate electrode of the driving transistor.

15. The driving method of claim 1, wherein:
the display device comprises a scan driver that drives a display panel, and
the driving method comprises providing the power voltage to the scan driver.

16. A display device comprising:
a display panel comprising pixels;
a data driver configured to provide a data voltage to the display panel;
a scan driver configured to provide a scan signal to the display panel; and
a power supply unit configured to provide a power voltage to the display panel and change the power voltage step by step based on a display brightness value (DBV),
wherein:
the display panel is configured to display an image with maximum luminance corresponding to the DBV,
the data driver is configured to correct gamma voltage values in a first DBV where a step occurs in the power voltage and generate a data voltage based on the corrected gamma voltage values, and
the data voltage for a first grayscale:
changes linearly based on the DBV in the DBV section where the power voltage is maintained constant, and
changes non-linearly or a discontinuously in:
the DBV section where the step of the power voltage occurs, or
the first DBV.

17. The display device of claim 16, further comprising a memory storing a lookup table, wherein:
the lookup table comprises information on voltage levels of the power voltage based on one or more DBVs within a DBV range, and
the data driver is configured to:
determine a voltage level at each step of the power voltage by interpolating voltage levels in the lookup table, and
determine the first DBV based on the voltage level at the each step.

18. The display device of claim 16, wherein the data driver is configured to:
set an offset for the DBV based on the first DBV, and
correct the gamma voltage values based on the DBV based on the offset.

19. The display device of claim 18, wherein the data driver is configured to:
set a first offset for the first DBV corresponding to a starting point of the step, and
set a second offset for a second DBV corresponding to an ending point of the step.

20. The display device of claim 19, wherein the data driver is configured to:
set the first offset such that luminance of the display panel is lowered within a correction range, and
set the second offset such that the luminance is higher within the correction range.

21. An electronic device, comprising:
a processor to provide input image data;
a display module to display an image based on the input image data; and
a memory to store data information used to operate the display module,
wherein the display module comprises:
a display panel comprising pixels;
a data driver configured to provide a data voltage to the display panel;
a scan driver configured to provide a scan signal to the display panel; and
a power supply unit configured to provide a power voltage to the display panel and change the power voltage step by step based on a display brightness value (DBV),
wherein:
the display panel is configured to display an image with maximum luminance corresponding to the DBV,
the data driver is configured to correct gamma voltage values in a first DBV where a step occurs in the power voltage and generate a data voltage based on the corrected gamma voltage values, and
the data voltage for a first grayscale:
changes linearly based on the DBV in the DBV section where the power voltage is maintained constant, and
changes non-linearly or a discontinuously in:
the DBV section where the step of the power voltage occurs, or
the first DBV.

22. The electronic device of claim 21, further comprising a memory storing a lookup table, wherein:
the lookup table comprises information on voltage levels of the power voltage based on one or more DBVs within a DBV range, and
the data driver is configured to:
determine a voltage level at each step of the power voltage by interpolating voltage levels in the lookup table, and
determine the first DBV based on the voltage level at the each step.

23. The electronic device of claim 21, wherein the data driver is configured to:
set an offset for the DBV based on the first DBV, and
correct the gamma voltage values based on the DBV based on the offset.

24. The electronic device of claim 23, wherein the data driver is configured to:
set a first offset for the first DBV corresponding to a starting point of the step, and
set a second offset for a second DBV corresponding to an ending point of the step.

25. The electronic device of claim 24, wherein the data driver is configured to:
set the first offset such that luminance of the display panel is lowered within a correction range, and
set the second offset such that the luminance is higher within the correction range.
